(19) United States
(12) Patent Application Publication
(10) Pub. No.: US 2026/0222768 A1
(43) Pub. Date: Jul. 30, 2026

(54) Method For Testing and Locating a Tag Unit of an Asset Tracking System

(71) Applicant: RF Technologies, Inc., Brookfield, WI (US)

(72) Inventors: Robert F. Fillinger, Menomonee Falls, WI (US); Robert G. Metzler, Brookfield, WI (US); Ryan Beal, Hartland, WI (US)

(21) Appl. No.: 19/038,203

(22) Filed: Jan. 27, 2025

(51) Int. Cl. H04W 4/029; H04W 68/00

(52) U.S. Cl. CPC H04W 4/029; H04W 68/005

(57) ABSTRACT

A method is provided for testing and locating a tag unit of an asset tracking system. The tag unit transmits data periodically to a station to facilitate locating the tag unit. A notification is sent to the tag unit in advance of a transmission of data to the station. An alarm with the tag unit in conjunction with the transmission of the data in response to the notification.

### BACKGROUND OF THE INVENTION

### 1. Field of the Invention

This invention relates generally to an asset tracking system, and in particular, to a method for testing and/or locating a tag unit of an asset tracking system which is not in constant communication with a wireless network.

### 2. Discussion of the Related Art

Asset tracking systems can be utilized to locate, track and secure valuable, moveable assets. Typically, an asset tracking system includes a plurality of electronic tag units that utilize low power radio signals to provide instantaneous or somewhat instantaneous location of any asset or person. Each asset that is equipped with such an electronic tag can be considered a “tagged asset.” The system can maintain a complete log of movements for auditing security, generate instant inventory of all tagged assets, trigger alerts if the tag leaves or enters specified areas, and monitor and control access to and movements of assets. These conventional systems can be utilized in hospitals, industrial/commercial environments and high level security environments. The tagged assets may include, but are not limited to, people such as medical staff or patients, as well as equipment such as wheelchairs, hospital beds, and monitors.

In operation, wireless, battery powered tag units are attached to the assets for real-time or quick locating of a tagged asset and personal management throughout a facility. The tag units may include a tamper detection security feature which prevents theft and loss of equipment by causing an alert when the tag unit is removed from the asset. Additionally, the tag unit incorporates a low frequency transmitter that is configured to provide a low frequency signal that communicates with door alarms to stop equipment or people from leaving the facility or areas of the facility. Tag units can be configured to lock down doors and elevators, generate alarms, and display alerts to an end user.

By way of example, Heinze et al., U.S. Pat. No. 8,373,562 (incorporated herein by reference), discloses an asset tracking system including a station, transmitting points, and tag units. The tag units are used for communicating with the transmitting points. Typically, each tag unit wakes up periodically and sends probe requests to all transmitting points in the vicinity. The transmitting points send probe responses to the tag unit. The tag unit, in turn, collects data associated with signal strengths between transmitting points and the tag unit and transmits the data to the station. The station receives data associated with the signal strengths between the transmitting points and the tag unit and analyzes the data to determine the location of the tag unit.

In order to locate the tag unit in cases of emergency or to test the tag unit, a manually actuatable button is provided on the tag unit. The button acts as the primary alert trigger. When the button is held for a predetermined amount of time, the tag unit will enter into an alarm state. In the alarm state, the tag unit immediately wakes up and sends probe requests to all transmitting points in the vicinity. The transmitting points send probe responses to the tag unit. The tag unit, in turn, collects the data associated with signal strengths of the responses between transmitting points and the tag unit and transmits the data to the station. The station receives data associated with the signal strengths between the transmitting points and the tag unit and analyzes the data to determine the current location of the tag unit, and in the case of a test, determine if the tag unit is functioning properly.

While functional for its intended purpose, the asset tracking system disclosed in the '562 patent has certain limitations. For example, as described above, in order to test the tag unit, the tag unit would have to be physically located and actuated by an individual. It can be appreciated that locating each tag unit and depressing the button on each tag unit can be extremely time consuming and burdensome. Similarly, if a tag unit is lost or misplaced, finding the tag unit between its periodic probe requests and transmission of data to the station would be all but impossible.

Therefore, it is a primary object and feature of the present invention to provide a method for testing and/or locating a tag unit of an asset tracking system which is not in constant communication with a wireless network.

It is a further object and feature of the present invention to provide a method for testing and/or locating a tag unit of an asset tracking system which allows for an administrator to test and/or locate a large number of tag units simultaneously.

It is a still further object and feature of the present invention to provide a method for testing and/or locating a tag unit of an asset tracking system which has a minimal effect on the battery life of tag unit.

It is a still further object and feature of the present invention to provide a method for testing and/or locating a tag unit of an asset tracking system which is simple and inexpensive to implement.

### SUMMARY

In accordance with the present invention, a method is provided for testing and locating a tag unit of an asset tracking system. The tag unit transmits data periodically to a station to facilitate location of the tag unit. A notification is sent to the tag unit in advance of a transmission of data to the station. An alarm is generated by the tag unit in conjunction with the transmission of the data in response to the notification.

The tag unit includes an actuator. The alarm is terminated in response to actuation of the actuator of the tag unit. To facilitate location of the tag unit, the tag unit repeatedly transmits the data to the station in response to the notification. The tag unit terminates the repeated transmission of the data in response to actuation of the actuator. The tag unit communicates with the station over a wireless network.

A probe signal is periodically transmitted by the tag unit. Thereafter, the tag unit receives signals of various strengths from a plurality of transmitting points in response to the probe signal. The data periodically transmitted to the station corresponds to the strengths of the signals received. The location of the tag unit is calculated in response to the data periodically transmitted to the station.

In accordance with a further aspect of the present invention, a method is provided for testing and locating tag units of an asset tracking system. The method includes the transmitting data periodically from at least one of a plurality of tag units to a station. The data corresponds to a location of the at least one of the plurality of tag units. A notification is transmitted to the at least one of the plurality of tag units in advance of a transmission of data to the station. An alarm is generated with the at least one of the plurality of tag units in conjunction with a subsequent transmission of data after receipt of the notification.

Each of the plurality of tag units includes an actuator. The at least one of the plurality of tag units terminates the alarm in response to actuation of the actuator. In addition or alternatively, the at least one of the plurality of tag units may repeatedly transmit the data to the station in response to the notification. The at least one of the plurality of tag units terminates the repeated transmission of the data in response to actuation of the actuator. Each of the plurality of tag units is connected to a wireless network. Each of the plurality of tag units communicates with the station over the wireless network.

A probe signal is periodically transmitted by the at least one of the plurality of tag units. Signals of various strengths are received from a plurality of transmitting points with the at least one of the plurality of tag units in response to the probe signal. The data periodically transmitted by the at least one of the plurality of tag units to the station corresponds to the strengths of the signals received. The location of the at least one of the plurality of tag units is calculated in response to the data periodically transmitted to the station.

In accordance with a still further aspect of the present invention, a method is provided for testing and locating tag units of an asset tracking system. The method includes periodically transmitting a probe signal from each of a plurality of tag units. Each of the plurality of tag units receives signals of various strengths from a plurality of transmitting points in response to the probe signal. Data is periodically transmitted from each of the plurality of tag units to a station. The data corresponds to the signals of various strengths from the plurality of transmitting points by each of the plurality of tag units. A notification is transmitted to at least one of the plurality of tag units in advance of a transmission of data to the station. An alarm is generated with the at least one of the plurality of tag units in conjunction with a subsequent transmission of data after receipt of the notification.

Each of the plurality of tag units includes an actuator. The at least one of the plurality of tag units terminates the alarm in response to actuation of the actuator.

In addition or alternatively, the at least one of the plurality of tag units may repeatedly transmit the data to the station in response to the notification. The location of the at least one of the plurality of tag units is determined in response to the data periodically transmitted to the station. The at least one of the plurality of tag units terminates the repeated transmission of the data in response to actuation of the actuator. Each of the plurality of tag units communicates with the station over the wireless network.

These and other features and advantages of the invention will become apparent to those skilled in the art from the following detailed description and the accompanying drawings. It should be understood, however, that the detailed description and specific examples, while indicating preferred embodiments of the present invention, are given by way of illustration and not of limitation. Many changes and modifications may be made within the scope of the present invention without departing from the spirit thereof, and the invention includes all such modifications.

### BRIEF DESCRIPTION OF THE DRAWINGS

Preferred exemplary embodiments of the invention are illustrated in the accompanying drawings in which like reference numerals represent like parts throughout, and in which:

FIG. 1 is a schematic representation of an asset tracking system for effectuating the methodology of the present invention;

FIG. 2 is a schematic representation of an access point for the asset tracking system of FIG. 1;

FIG. 3 is a schematic representation of a tag unit for the asset tracking system of FIG. 1;

FIG. 4 is a flowchart illustrating operation of the asset tracking system of FIG. 1;

FIG. 5 is a flowchart illustrating a testing operation for a tag unit of the asset tracking system of FIG. 1; and

FIG. 6 is a flowchart illustrating a locating operation for a tag unit of the asset tracking system of FIG. 1.

### DETAILED DESCRIPTION OF THE DRAWINGS

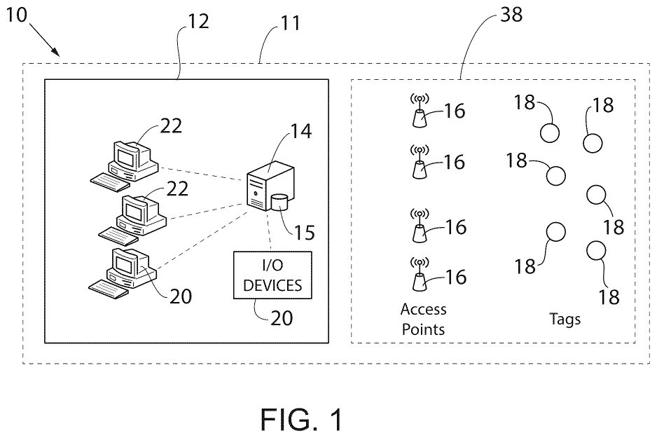

Referring to FIG. 1, an asset tracking system for effectuating the methodology of the present invention is generally designated by the reference numeral 10. It can be appreciated that asset tracking system 10 is intended to track one or more tag units 18 which many be interconnected to an asset, such as a person or a piece of equipment. Asset tracking system 10 is implemented in a wireless communication operating environment, e.g. a WLAN (wireless local area network) operating environment, designated by the reference numeral 11, between the various components of asset tracking system 10, as hereinafter described.

Asset tracking system 10 includes a station or hub 12, one or more wireless transmitting/access points 16 and one or more tag units 18 or simply “tags”. Hub 12 includes a microprocessor, a microcontroller or other programmable logic element (individually and collectively considered “a server” and generally designated by the reference numeral 14) configured to execute a program stored in non-volatile memory 15. Hub 12 additionally includes a wireless I/O communication device 20 to broadcast and receive wireless signals over WLAN 11, and one or more user interfaces 22 through which users may interact with components of asset tracking system 10, including server 14, access points 16, and tag units 18. It is contemplated for server 14 to execute a positioning program stored in non-volatile memory 15 to determine the location of one or more tag units 18 based on calibration data collected during initial installation, historical movements of tag unit 18, and statistical analysis, as hereinafter described.

Referring to FIG. 2, each access point 16 may be battery powered or wired to a power source, as shown herein as power supply 34. Each access point 16 has circuitry 36 that includes corresponding hardware, firmware, software, or any combination thereof. Circuitry 36 further includes two radios operating at different frequencies. A first, “primary” radio 30 operates at a first frequency, typically at a relatively high frequency, typically of 2.4 GHz to 5 GHZ, during period o+9f normal conductivity to perform to effectuate communication on WLAN 11 and allow for the transmission of data between hub 12, access points 16, and tag units 18. The second or “secondary” radio 32 operates at a second frequency in the RF range to effectuate communications between access points 16 and tag units 18 on a local area network (LAN), generally designated by the reference numeral 38, FIG. 1, as hereinafter described. As is typical, circuitry 36 of each access point 16 performs various tasks such as network packet switching, network security enforcement (traffic filtering, session encryption, etc.), and spectrum monitoring to identify issues that might affect radio performance.

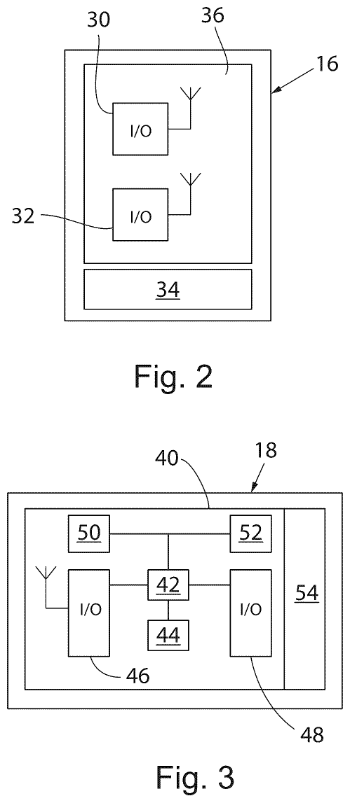

Referring to FIG. 3, each tag unit 18 is configured to perform any of a variety of communication functions, including the acquisition and transmission of data, as hereinafter described. Each tag unit 18 may be powered by battery 54 or be wired to a power source, and includes controller 40 having a processor 42 and non-transient memory storage 44, a wireless I/O communication device 46 and a radio frequency (RF) transceiver 48. In addition, each tag unit 18 further includes audio device 50, such as a speaker, configured for providing audible alerts, Finally, each tag unit 18 includes a pushbutton actuator 52. As is typical, each tag unit 18 includes a unique identifier assigned thereto for use as a network address for communications within WLAN 11.

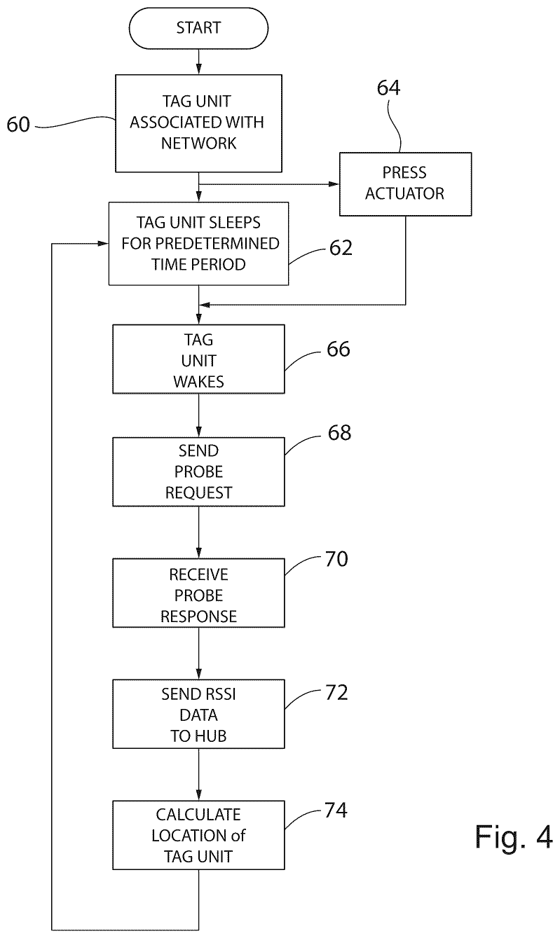

Referring to FIG. 4, a process for determining the location of a tag unit is illustrated in the form of a flowchart. Once connected to WLAN 11, each tag unit 18 will initially send an association request on WLAN 11 to access points 16 in the vicinity. As is conventional, if the elements in the association request match the capabilities of access points 16, access points 16 will create an association identification for a corresponding tag unit 18 and will respond with an association response with a success message granting network access to the corresponding tag unit 18, block 60.

Once network access is granted to tag unit 18, tag unit 18 will enter a sleep state, block 62. Upon actuation of actuator 52 (e.g. in case of an emergency wherein the wearer of the tag unit needs immediate attention), block 64, tag unit 18 will immediately wake up, block 66, and send a probe request on LAN 38 to all access points 16 in the vicinity, block 68. Upon receipt of the probe request, each access point 16 sends a probe response back on LAN 38, which is received by tag unit 18, block 70. Tag units 18 measure the relative signal strengths of the broadcasted probe response signals received from multiple access points 16 and calculates the RSSI (received signal strength indication) values associated with specific access points 16. Tag unit 18 then transmits the RSSI values associated with access points 16 to hub 12 over WLAN 11, block 72. Upon receipt of the data associated with signal strengths between wireless access points 16 and tag unit 18, server 14 analyzes RSSI values associated with a number of transmitting access points 16 and determines the location of tag unit 18, block 74. More specifically, positioning program on server 14 determines the location of tag unit 18 based on the following: calibration data collected during initial installation; historical movements of tag unit 18; and statistical analysis, or any combination thereof. This information allows for assistance to be directed to wearer of tag unit 18 at the calculated location. Thereafter, tag unit 18 returns to its sleep state, block 62.

Alternatively, if actuator 52 is not actuated, tag unit 18 is configured to wake up at predetermined time periods, block 66, in order to periodically send a probe request on LAN 38 to all access points 16 in the vicinity, block 68, thereby allowing the location of the wearer of the tag unit 18 to be tracked. Upon receipt of the probe request, each access point 16 sends a probe response back on LAN 38, which is received by tag unit 18 in the vicinity, block 70. Tag unit 18 measures the relative signal strengths of broadcasted probe response signals received from multiple access points 16 and calculates the RSSI values associated with specific access points 16. Thereafter, each tag unit 18 transmits the RSSI values associated with access points 16 to hub 12 over WLAN 11, block 72. Upon receipt of the data associated with signal strengths between wireless access points 16 and a corresponding tag unit 18, server 14 analyzes RSSI values associated with a number of transmitting access points 16 and determines the location of tag unit 18, block 74. As previously noted, positioning program determines the location of tag unit 18 based on the following: calibration data collected during initial installation; historical movements of tag unit 18; and statistical analysis, or any combination thereof. Thereafter, tag unit 18 returns to its sleep state, block 62.

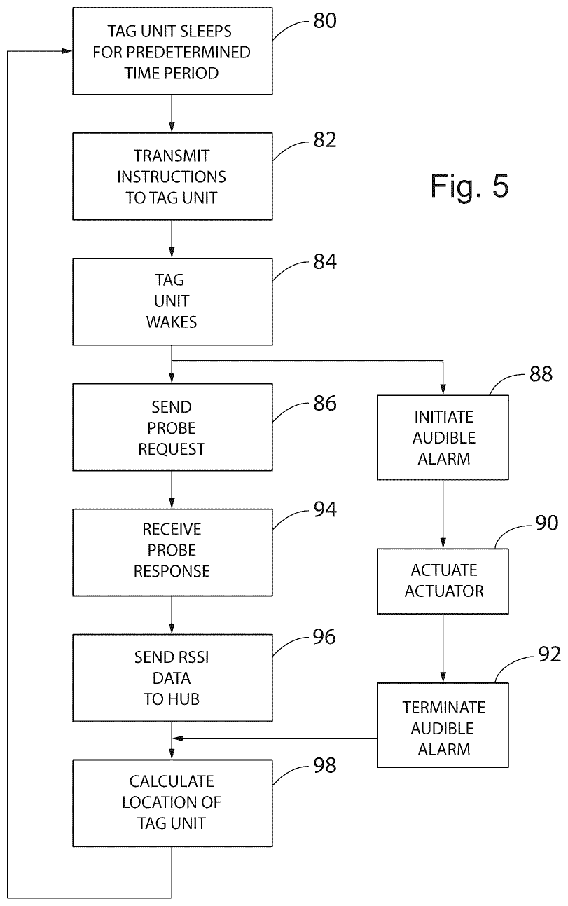

A process for locating a tag unit in its sleep state is illustrated by way of the flowchart of FIG. 5. In order to locate one or more tag units 18 in its sleep state, block 80, it is contemplated for a user to utilize the user interface of hub 12 to selectively request the location of the one or more tag units 18. Upon receiving the request, server 14 transmits instructions to the one or more tag units 18 to generate an audible alert on audio device 50, block 82. When the one or more tag units 18 wakes up, block 84, to send the probe request on LAN to all access points 16 in the vicinity, as heretofore described, the one or more tag units 18 receives the instructions from server 14 to generate to generate an audible alert on audio device 50, block 88. Hence, in addition to sending the probe request on LAN to all access points 16 in the vicinity, each controller 40 of the one or more tag units 18 causes an audible alert to be generated on audio device 50, block 88. Upon actuation of actuator 52 by an individual, block 90, the audible alert is terminated, block 92.

In addition, upon receipt of the probe request, each access point 16 sends a probe response back on LAN, which is received by tag unit 18 in the vicinity, block 94. Tag unit 18 measures the relative signal strengths of broadcasted probe response signals received from multiple access points 16 and calculates the RSSI values associated with specific access points 16. Thereafter, each tag unit 18 transmits the RSSI values associated with access points 16 to hub 12 over WLAN 11, block 96. Upon receipt of the data associated with signal strengths between wireless access points 16 and a corresponding tag unit 18, server 14 analyzes RSSI values associated with a number of transmitting access points 16 and determines the location of tag unit 18, block 98. As previously noted, the positioning program determines the location of tag unit 18 based on the following: calibration data collected during initial installation; historical movements of tag unit 18; and statistical analysis, or any combination thereof. It can be appreciated that the audible alarm coupled with the calculation of the location of tag unit 18 by the positioning program will greatly enhance the ability of an individual to locate a tag unit. Once the one or more tag units 18 are located, the one or more tag units returns to the sleep state, block 80.

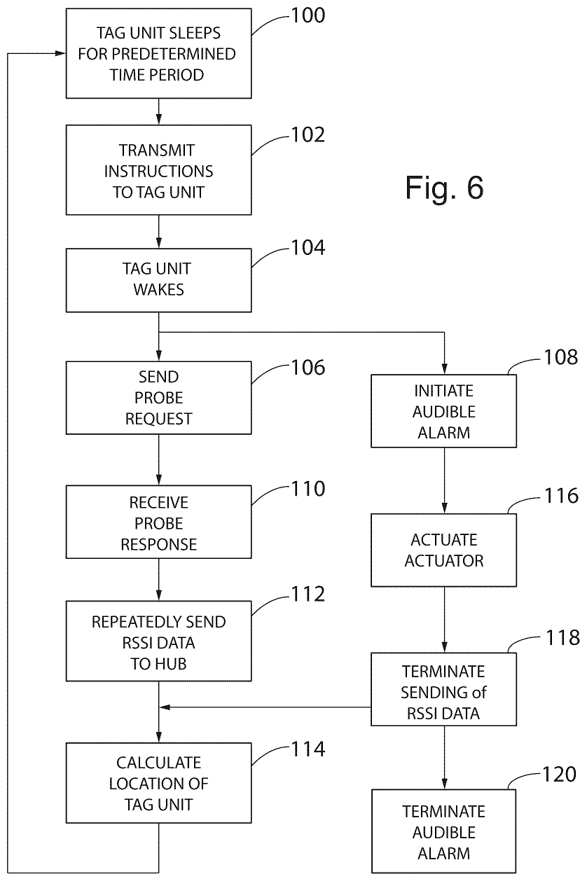

Referring to the flowchart of FIG. 6, in the event an administrator would like to test one or more tag units, it is contemplated for a user to utilize the user interface of hub 12 to selectively request the testing of the one or more tag units 18 while the one or more tag units 18 is in a sleep state, block 100. Upon request, hub 12 transmits instructions to the one or more tag units 18 indicating the request for the one or more tag units 18 to be tested and requesting the one or more tag units 18 to generate an audible alert on audio device 50, block 102. When the one or more tag units 18 wakes up, block 104, to send the probe request on LAN 38 to all access points 16 in the vicinity, as heretofore described, the one or more tag units 18 receives the instructions from hub 12. In response, each of the one or more tag units 18 sends out the probe request on LAN 38 to all access points 16 in the vicinity, block 106. In addition, each controller 40 of the one or more tag units 18 causes an audible alert to be generated on audio device 50, block 108.

Upon receipt of the probe request, each access point 16 sends a probe response back on LAN, which is received by any tag units 18 in the vicinity, block 110. Tag unit 18 measures the relative signal strengths of broadcasted probe response signals received from multiple access points 16 and calculates the RSSI values associated with specific access points 16. Thereafter, each tag unit 18 repeatedly transmits the RSSI values associated with access points 16 to hub 12 over WLAN 11, block 112. Upon receipt of the data associated with signal strengths between wireless access points 16 and a corresponding tag unit 18, server 14 analyzes the RSSI values associated with a number of transmitting access points 16 and determines the location of tag unit 18, block 114. As previously noted, positioning program determines the location of tag unit 18 based on the following: calibration data collected during initial installation; historical movements of tag unit 18; and statistical analysis, or any combination thereof.

It is contemplated for the audible alert to continue and for the repeated transmission of the RSSI values associated with access points 16 to hub 12 over WLAN 11 by each of the one or more tag units 18 until actuation of actuator 52 by an individual. Upon actuation of actuator 52, block 116, the repeated transmission of the RSSI values associated with access points 16 to hub 12 over WLAN 11 is terminated, block 118, and the audible alert is terminated, block 120. It can be appreciated that the audible alarm coupled with the calculation of the location of tag unit 18 by the positioning program allows a user to simply and easily test the capabilities of one or more tag units 18 simultaneously, a significant advantage over the art. Once the test is complete, the one or more tag units 18 return to their sleep state, block 100.

Although the best mode contemplated by the inventors of carrying out the present invention is disclosed above, practice of the above invention is not limited thereto. It will be manifest that various additions, modifications and rearrangements of the features of the present invention may be made without deviating from the spirit and the scope of the underlying inventive concept.

It should be appreciated that such a development effort might be complex and time consuming, but would nevertheless be a routine undertaking of design, fabrication, and manufacture for those of ordinary skill having the benefit of this disclosure. Nothing in this application is considered critical or essential to the present invention unless explicitly indicated as being “critical” or “essential.”

We claim:

1. A method for testing and locating a tag unit of an asset tracking system, the tag unit transmitting data periodically to a station to facilitate location of the tag unit, comprising:
transmitting a notification to the tag unit in advance of a transmission of data to the station; and
in response to the notification, generating an alarm with the tag unit in conjunction with the transmission of the data.

2. The method of claim 1, wherein the tag unit includes an actuator, the tag unit terminating the alarm in response to actuation of the actuator.

3. The method of claim 1, wherein the tag unit repeatedly transmits the data to the station in response to the notification.

4. The method of claim 3, wherein the tag unit includes an actuator, the tag unit terminating the repeated transmission of the data in response to actuation of the actuator.

5. The method of claim 1, further comprising connecting the tag unit to a wireless network, the tag unit communicating with the station over the wireless network.

6. The method of claim 5, further comprising:
periodically transmitting a probe signal with the tag unit; and
receiving signals of various strengths from a plurality of transmitting points in response to the probe signal;
wherein the data periodically transmitted to the station corresponds to the strengths of the signals received.

7. The method of claim 6, further comprising calculating the location of the tag unit in response to the data periodically transmitted to the station.

8. A method for testing and locating tag units of an asset tracking system, comprising:
transmitting data periodically from at least one of a plurality of tag units to a station, the data corresponding to a location of the at least one of the plurality of tag units;
transmitting a notification to the at least one of the plurality of tag units in advance of a transmission of data to the station; and
generating an alarm with the at least one of the plurality of tag units in conjunction with a subsequent transmission of data after receipt of the notification.

9. The method of claim 8, wherein each of the plurality of tag units includes an actuator, the at least one of the plurality of tag units terminating the alarm in response to actuation of the actuator.

10. The method of claim 8, wherein the at least one of the plurality of tag units repeatedly transmits the data to the station in response to the notification.

11. The method of claim 10, wherein each of the plurality of unit includes an actuator, the at least one of the plurality of tag units terminating the repeated transmission of the data in response to actuation of the actuator.

12. The method of claim 8, comprising connecting each of the plurality of tag units to a wireless network, each of the plurality of tag units communicating with the station over the wireless network.

13. The method of claim 8, further comprising:
periodically transmitting a probe signal with the at least one of the plurality of tag units; and
receiving signals of various strengths from a plurality of transmitting points with the at least one of the plurality of tag units in response to the probe signal;
wherein the data periodically transmitted by the at least one of the plurality of tag units to the station corresponds to the strengths of the signals received.

14. The method of claim 13, further comprising calculating the location of the at least one of plurality of tag units in response to the data periodically transmitted to the station.

15. A method for testing and locating tag units of an asset tracking system, comprising:
periodically transmitting a probe signal from each of a plurality of tag units, each of the plurality of tag units receiving signals of various strengths from a plurality of transmitting points in response to the probe signal;
transmitting data periodically from each of the plurality of tag units to a station, the data corresponding to the signals of various strengths from the plurality of transmitting points by each of the plurality of tag units;
transmitting a notification to at least one of the plurality of tag units in advance of a transmission of data to the station; and
generating an alarm with the at least one of the plurality of tag units in conjunction with a subsequent transmission of data after receipt of the notification.

16. The method of claim 15, wherein each of the plurality of tag units includes an actuator, the at least one of the plurality of tag units terminating the alarm in response to actuation of the actuator.

17. The method of claim 15, wherein the at least one of the plurality of tag units repeatedly transmits the data to the station in response to the notification.

18. The method of claim 17, further comprising determining the location of the at least one of the plurality of tag units in response to the data periodically transmitted to the station.

19. The method of claim 17, wherein each of the plurality of tag units includes an actuator, the at least one of the plurality of tag units terminating the repeated transmission of the data in response to actuation of the actuator.

20. The method of claim 15, further comprising connecting each of the plurality of tag units to a wireless network, each of the plurality of tag units communicating with the station over the wireless network.
